(19) United States
(12) Patent Application Publication
(10) Pub. No.: US 2010/0158526 A1
(43) Pub. Date: Jun. 24, 2010

(54) OPTICAL TRANSCEIVER SUITABLE FOR USE IN HYBRID, PASSIVE OPTICAL NETWORK

(76) Inventors: Han-hyub Lee, Daejeon-si (KR); Byoung-whi Kim, Daejeon-si (KR); Seung-hyun Cho, Daejeon-si (KR); Jea-hoon Yu, Daejeon-si (KR); Jai-sang Koh, Gwangju-si (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/638,696

(22) Filed: Dec. 15, 2009

(30) Foreign Application Priority Data
Dec. 22, 2008 (KR) 10-2008-0131578

(51) Int. Cl. H04J 14/00

(52) U.S. Cl. 398/75; 398/135

(57) ABSTRACT

Provided is an apparatus for connecting a wavelength division multiplexing passive optical network (WDM-PON) to a time division multiplexing passive optical network (TDM-PON). In a hybrid, passive optical network which is a combination of the WDM-PON and the TDM-PON, the apparatus is formed at a subscriber side for matching the WDM-PPN and the TDM-PON. Accordingly, a passive remote mode can be implemented as a passive node not an active node. Therefore, the entire optical network can be efficiently operated. In addition, since the apparatus located on the subscriber side uses a wavelength-tunable light source, any dependency on the wavelength of a WDM-PON optical signal is removed.

### CROSS-REFERENCE TO RELATED APPLICATION

This application claims the benefit under 35 U.S.C. §119(a) of Korean Patent Application No. 10-2008-0131578, filed on Dec. 22, 2008, the disclosure of which is incorporated by reference in its entirety for all purposes.

### BACKGROUND

1. Field

The following description relates to a technology involving optical transmission and reception in a passive optical network, and more particularly, to a technology involving optical transmission and reception in a hybrid, passive optical network which is a combination of a wavelength division multiplexing passive optical network (WDM-PON) and a time division multiplexing passive optical network (TDM-PON).

2. Description of the Related Art

A wavelength division multiplexing passive optical network (WDM-PON) and a time division multiplexing passive optical network (TDM-PON) are currently being developed to increase the efficiency of using an optical fiber connected between a central office and subscriber premises and provide each subscriber with a fast optical communication environment.

An optical signal is transmitted from a central office to a remote node using a WDM-PON method. Then, the optical signal goes through, for example, a wavelength conversion process at the remote node and is transmitted to one or more optical network units (ONUs) at the subscriber side using a TDM-PON method.

In a WDM-PON, a wavelength division-multiplexed downstream signal, which is output from an optical line terminal (OLT) at a central office and has a plurality of wavelengths, is divided by a 1×N wavelength multiplexer and then transmitted to one or more ONUs at the subscriber side. In addition, signals, which are output respectively from the ONUs, each of which having a single wavelength, are combined by an N×1 wavelength multiplexer and are then transmitted to the central office.

In a TDM-PON, a downstream signal, which is output from an OLT at a central office and has a single wavelength, is divided by a 1×N optical strength divider and is then transmitted to one or more ONUs at the subscriber side. In addition, signals, which are output respectively from the ONUs, each of which having a single wavelength, are combined by an N×1 optical coupler and then transmitted to the central office. Unlike in the WDM-PON, in the TDM-PON, N ONUs share an upstream signal having a single wavelength. Thus, each ONU at the subscriber side can transmit the upstream signal only in a time frame allocated thereto, in response to a control signal received from the central office. To set the time frame, the OLT of is the TDM-PON must include a media access control (MAC) unit.

An optical device for optical amplification and wavelength conversion and a MAC unit are installed at a remote node and are active devices that operate when supplied with power. When operating, the devices are sensitive to temperature. Thus, cooling and heating facilities are required to maintain an appropriate temperature, which incurs personnel and operational costs needed to maintain and manage the cooling and heating facilities.

### SUMMARY

The following description relates to an optical transceiver suitable for use in a hybrid, passive optical network, the optical transceiver including a passive remote node formed by installing an active optical device for optical amplification and wavelength conversion and a media access control (MAC) unit at a subscriber side of a remote node at which they are installed, thereby efficiently operating the entire optical network.

According to an exemplary aspect, there is provided an optical transceiver suitable for use in a hybrid, passive optical network. The optical transceiver is installed at a subscriber side and includes: a first signal processing unit converting a wavelength of a first optical signal received from a central office and transmitting the first optical signal with the converted wavelength to one or more optical network units (ONUs); a second signal processing unit converting a wavelength of a second optical signal received from each of the ONUs and transmitting the second optical signal with the converted wavelength to the central office; and a MAC unit setting a time frame in which each of the ONUs can transmit the second optical signal.

The first signal processing unit may include: a first receiver receiving the first optical signal from the central office; and a first transmitter converting the wavelength of the first optical signal received by the first receiver and transmitting the first optical signal with the converted wavelength to the ONUs, wherein the first receiver may be connected to the central office by a wavelength division multiplexing passive optical network (WDM-PON), and the first transmitter may be connected to the ONUs by a time division multiplexing passive optical network (TDM-PON).

The second signal processing unit may include: a second receiver receiving the second optical signal from each of the ONUs; and a second transmitter converting the wavelength of the second optical signal received by the second receiver and transmitting the second optical signal with the converted wavelength to the central office, wherein the second receiver may be connected to the ONUs by the TDM-PON, and the second transmitter may be connected to the central office by the WDM-PON.

The first receiver may be configured using either a P-I-N photodiode or an avalanched photodiode.

The first transmitter may be configured using a directly modulated, wavelength-fixed light source.

The second receiver may be configured using either a P-I-N photodiode or an avalanched photodiode.

The second transmitter may be configured using a directly modulated reflective semiconductor optical amplifier or a Febry-Perot laser diode (FP-LD).

The optical transceiver may further include an optical amplification unit at a front end of the second transmitter, wherein the optical amplification unit is either a doped fiber amplifier or a semiconductor optical amplifier.

The first receiver and the second transmitter may be connected to either an optical circulator or an optical power splitter.

The second receiver and the first transmitter may be connected to either an optical circulator or an optical wavelength division multiplexing (WDM) filter.

The optical transceiver may further include an optical WDM filter multiplexing wavelengths of a WDM signal and a time division multiplexing (TDM) signal.

The optical transceiver may further include an optical power splitter at a front end of the first transmitter, wherein the optical power splitter can communicate with the ONUs.

Other objects, features and advantages will be apparent from the following description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain aspects of the invention.

FIG. 1 is a block diagram of an optical transceiver suitable for use in a hybrid, passive optical network according to an exemplary embodiment;

FIGS. 2A and 2B are block diagrams of a second transmitter according to exemplary embodiments;

FIG. 3 is a block diagram of an optical transceiver suitable for use in a hybrid, passive optical network according to another exemplary embodiment;

FIG. 4 is a block diagram of an optical transceiver suitable for use in a hybrid, passive optical network according to another exemplary embodiment;

FIG. 5 is a block diagram of an optical transceiver suitable for use in a hybrid, passive optical network according to another exemplary embodiment;

FIG. 6 is a block diagram of an optical transceiver suitable for use in a hybrid, passive optical network according to another exemplary embodiment;

FIG. 7 is a block diagram of an optical transceiver suitable for use in a hybrid, passive optical network according to another exemplary embodiment;

FIG. 8 is a block diagram of an optical transceiver suitable for use in a hybrid, passive optical network according to another exemplary embodiment;

FIG. 9 is a block diagram of an optical transceiver suitable for use in a hybrid, passive optical network according to another exemplary embodiment; and

FIG. 10 is a block diagram of an optical transceiver suitable for use in a hybrid, passive optical network according to another exemplary embodiment.

### DETAILED DESCRIPTION

The invention is described more fully hereinafter with reference to the accompanying drawings, in which exemplary embodiments of the invention are shown. Descriptions of well-known functions and constructions are omitted to increase clarity and conciseness. Also, the terms used in the following description are terms defined taking into consideration the functions obtained in accordance with the present invention, and may be changed in accordance with the option of a user or operator or a usual practice. Therefore, the definitions of these terms should be determined based on the entire content of this specification.

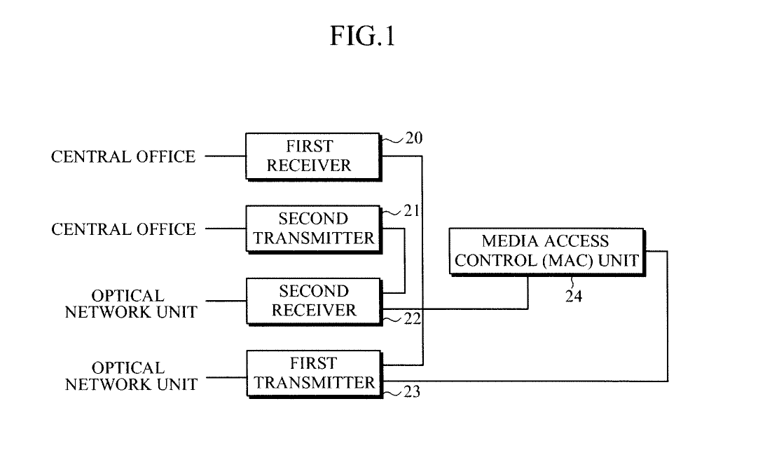

FIG. 1 is a block diagram of an optical transceiver suitable for use in a hybrid, passive optical network according to an exemplary embodiment.

Referring to FIG. 1, the optical transceiver of the hybrid, passive optical network includes a first signal processing unit, a second signal processing unit, and a media access control (MAC) unit 24. The first signal processing unit includes a first receiver 20 and a first transmitter 23, and the second signal processing unit includes a second transmitter 21 and a second receiver 22. The optical transceiver of the hybrid, passive optical network is located on the subscriber side.

The first signal processing unit converts a wavelength of a first optical signal received from a central office and transmits the first optical signal with the converted wavelength to one or more optical network units (ONUs). Specifically, the first receiver 20 receives the first optical signal from the central office, and the first transmitter 23 converts the wavelength of the first optical signal received by the first receiver 20 and transmits the first optical signal with the converted wavelength to the ONUs. Here, the first receiver 20 may be connected to the central office by a wavelength division multiplexing passive optical network (WDM-PON), and the first transmitter 23 may be connected to the ONUs by a time division multiplexing passive optical network (TDM-PON). In addition, the first receiver 20 may be configured using a P-I-N photodiode or an avalanched photodiode, and the first transmitter 23 may be configured using a directly modulated, wavelength-locked light source.

The second signal processing unit converts a wavelength of a second optical signal received from each of the ONUs and transmits the second optical signal with the converted wavelength to the central office. Specifically, the second receiver 22 receives the second optical signal from each of the ONEs, and the second transmitter 21 converts the wavelength of the second optical signal received by the second receiver 22 and transmits the second optical signal with the converted wavelength to the central office. Here, the second receiver 22 may be connected to the ONUs by the TDM-PON, and the second transmitter 21 may be connected to the central office by the WDM-PON. In addition, the second receiver 22 may be configured using a P-I-N diode or an avalanched photodiode.

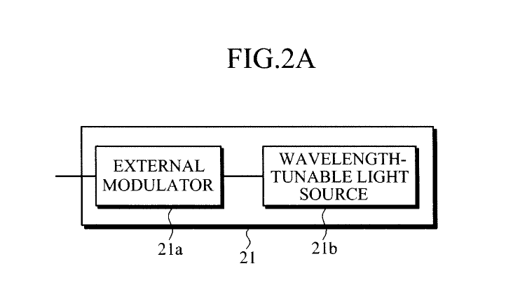

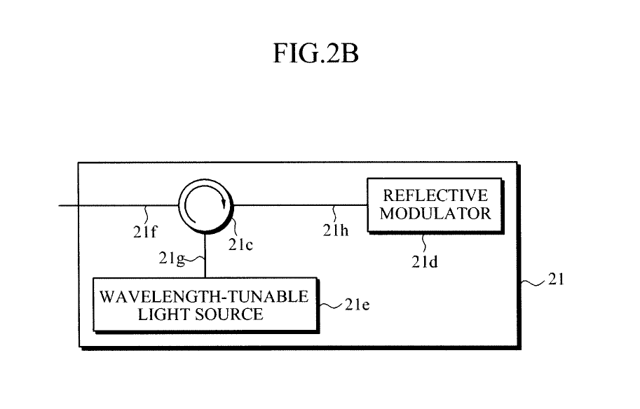

FIGS. 2A and 2B are block diagrams of a second transmitter according to exemplary embodiments.

Referring to FIG. 2A, the second transmitter 21 may be configured using a continuous output wavelength-tunable light source 21b and an external modulator 21a which modulates an optical signal output from the wavelength-tunable light source 21b. Alternatively, referring to FIG. 2B, the second transmitter 21 may be configured using a directly modulated, wavelength-tunable light source 21e, a reflective modulator 21d, and an optical circulator 21c. The directly modulated, wavelength-tunable light source 21e directly modulates an optical signal and outputs the directly modulated optical signal. The reflective modulator 21d reflects an optical signal output from the directly modulated, wavelength-tunable light source 21e. The optical circulator 21c receives an optical signal from the directly modulated, wavelength-tunable light source 21e via a terminal 21g and transmits the received optical signal to the reflective modulator 21d via a terminal 21h. In addition, the optical circulator 21c receives an optical signal reflected by the reflective modulator 21d via the terminal 21h and transmits the received optical signal to the central office via a terminal 21f.

The MAC unit 24 is connected to the first transmitter 23 and the second receiver 22 and sets a time frame in which each of the ONUs can transmit the second optical signal.

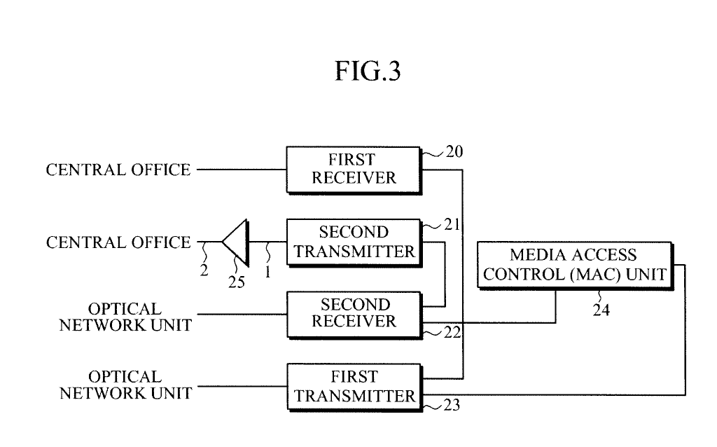

FIG. 3 is a block diagram of an optical transceiver suitable for use in a hybrid, passive optical network according to another exemplary embodiment.

Referring to FIG. 3, the optical transceiver of the hybrid, passive optical network is the same as that with respect to FIG. 3, except that it additional has an optical amplification unit 25.

The description of the optical transceiver of the hybrid, passive optical network is the same as that with respect to FIG. 1 except for the following. The first signal processing unit converts a wavelength of a first optical signal received from a central office and transmits the first optical signal with the converted wavelength to one or more ONUs. Specifically, the first receiver 20 receives the first optical signal from the central office, and the first transmitter 23 converts the wavelength of the first optical signal received by the first receiver 20 and transmits the first optical signal with the converted wavelength to the ONUs. Here, the first receiver 20 may be connected to the central office by the WDM-PON, and the first transmitter 23 may be connected to the ONUs by the TDM-PON. In addition, the first receiver 20 may be configured using a P-I-N photodiode or an avalanched photodiode, and the first transmitter 23 may be configured using a directly modulated, wavelength-locked light source.

The second signal processing unit converts a wavelength of a second optical signal received from each of the ONUs and transmits the second optical signal with the converted wavelength to the central office. Specifically, the second receiver 22 receives the second optical signal from each of the ONUs, and the second transmitter 21 converts the wavelength of the second optical signal received by the second receiver 22 and transmits the second optical signal with the converted wavelength to the central office. Here, the second receiver 22 may be connected to the ONUs by the TDM-PON, and the second transmitter 21 may be connected to the central office by the WDM-PON. In addition, the second receiver 22 may be configured using a P-I-N diode or an avalanched photodiode.

Referring to FIG. 2A, the second transmitter 21 may be configured using a continuous output wavelength-tunable light source 21b and an external modulator 21a which modulates an optical signal output from the wavelength-tunable light source 21b. Alternatively, referring to FIG. 2B, the second transmitter 21 may be configured using a directly modulated, wavelength-tunable light source 21e, a reflective modulator 21d, and an optical circulator 21c. The directly modulated, wavelength-tunable light source 21e directly modulates an optical signal and outputs the directly modulated optical signal. The reflective modulator 21d reflects an optical signal output from the directly modulated, wavelength-tunable light source 21e. The optical circulator 21c receives an optical signal from the directly modulated, wavelength-tunable light source 21e via a terminal 21g and transmits the received optical signal to the reflective modulator 21d via a terminal 21h. In addition, the optical circulator 21c receives an optical signal reflected by the reflective modulator 21d via the terminal 21h and transmits the received optical signal to the central office via a terminal 21f.

The MAC unit 24 is connected to the first transmitter 23 and the second receiver 22 and sets a time frame in which each of the ONUs can transmit the second optical signal.

The optical amplification unit 25 receives the second optical signal with the converted wavelength from the second transmitter 21 via a first terminal 1, amplifies the second optical signal, and transmits the amplified second optical signal to the central office via a second terminal 2. Since the second optical signal is amplified and then transmitted to the central office as described above, the quality of the second optical signal can be prevented from deteriorating while being transmitted to the central office.

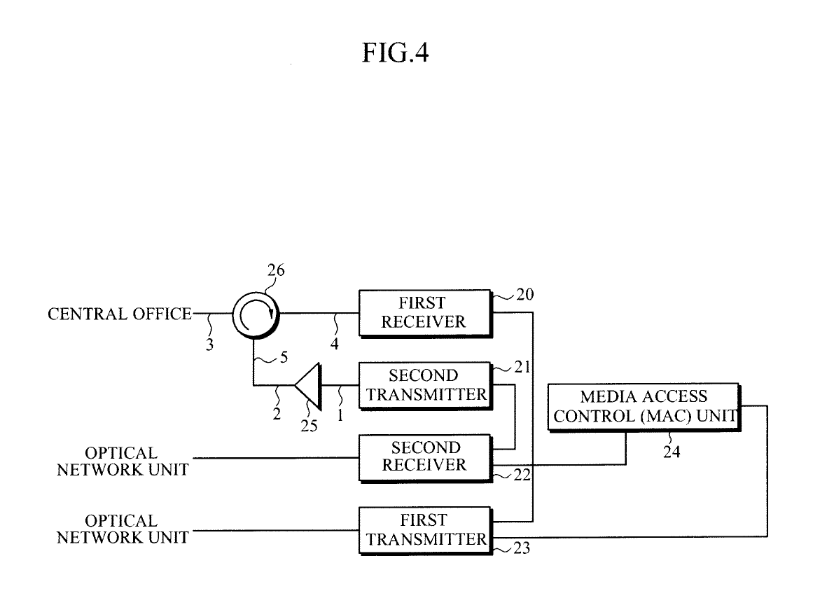

FIG. 4 is a block diagram of an optical transceiver suitable for use in a hybrid, passive optical network according to another exemplary embodiment.

Referring to FIG. 4, the optical transceiver of the hybrid, passive optical network includes a first signal processing unit, a second signal processing unit, a MAC unit 24, an optical amplification unit 25, and a first optical circulation unit 26. The first signal processing unit includes a first receiver 20 and a first transmitter 23, and the second signal processing unit includes a second transmitter 21 and a second receiver 22. The optical transceiver of the hybrid, passive optical network is located on the subscriber side.

The description of the optical transceiver of the hybrid, passive optical network is the same as that with respect to FIGS. 1 and 3 except for the following. The above-described elements will not be reiterated.

The first optical circulation unit 26 receives the first optical signal from the central office via a third terminal 3 and transmits the received first optical signal to the first receiver 20 via a fourth terminal 4. In addition, the first optical circulation unit 26 receives the second optical signal from the optical amplification unit 25 via a fifth terminal 5 and transmits the received second optical signal to the central office via the third terminal 3. The first optical circulation unit 26 reduces the number of optical fibers required, which provide input signals, from four in the embodiments described with respect to FIGS. 1 and 3 to three in the current embodiment.

An optical splitter or a first optical filter (not shown) may substitute for the first optical circulation unit 26. The optical splitter may transmit an optical signal which has been transmitted from the second transmitter 21 and converted by the optical amplification unit 25 to each of the ONUs, and receive the optical signal from each of the ONUs and transmit the optical signal to the first receiver 20. The optical filter may receive the first optical signal from at least one of the ONUs via the third terminal 3 and transmit the received first optical signal to the first receiver 20 via the fourth terminal 4, and receive the amplified second optical signal from the optical amplification unit 25 via the second terminal 2 and transmit the received second optical signal to the central office via the third terminal 3.

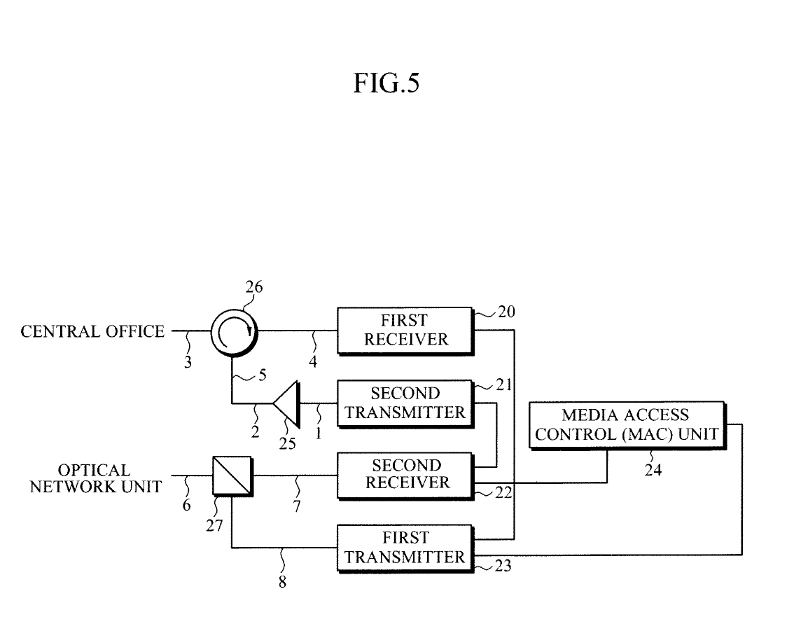

FIG. 5 is a block diagram of an optical transceiver suitable for use in a hybrid, passive optical network according to another exemplary embodiment.

Referring to FIG. 5, the optical transceiver of the hybrid, passive optical network includes a first signal processing unit, a second signal processing unit, a MAC unit 24, an optical amplification unit 25, a first optical circulation unit 26, and a second optical filter 27. The first signal processing unit includes a first receiver 20 and a first transmitter 23, and the second signal processing unit includes a second transmitter 21 and a second receiver 22. The optical transceiver of the hybrid, passive optical network is located on the subscriber side.

The description of the optical transceiver of the hybrid, passive optical network is the same as that with respect to FIGS. 1, 3, and 4 except for the following. The above-described elements will not be reiterated.

The second optical filter 27 receives the second optical signal from each of the ONUs via a sixth terminal 6 and transmits the received second optical signal to the first receiver 20 via the to fourth terminal 4. In addition, the second optical filter 27 receives the first optical signal from the first transmitter 23 via an eighth terminal 8 and transmits the received first optical signal to the ONUs via the sixth terminal 6. The first optical circulation unit 26 and the second optical filter 27 reduce the number of optical fibers, which provide input signals, from four in the embodiments described with respect to FIGS. 1 and 3 to two in the current embodiment.

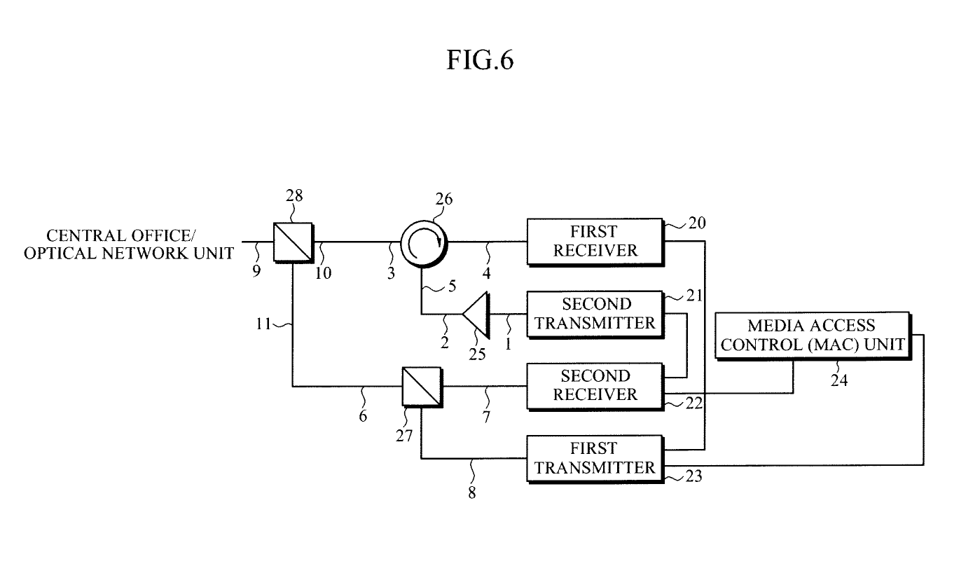

FIG. 6 is a block diagram of an optical transceiver suitable for use in a hybrid, passive optical network according to another exemplary embodiment.

Referring to FIG. 6, the optical transceiver of the hybrid, passive optical network includes a first signal processing unit, a second signal processing unit, a MAC unit 24, an optical amplification unit 25, a first optical circulation unit 26, a second optical filter 27, and a third optical filter 28. The first signal processing unit includes a first receiver 20 and a first transmitter 23, and the second signal processing unit includes a second transmitter 21 and a second receiver 22. The optical transceiver of the hybrid, passive optical network is located on the subscriber side.

The third optical filter 28 receives the first optical signal from the central office via a ninth terminal 9 and transmits the received first optical signal to the first receiver 20 via a tenth terminal 10. In addition, the third optical filter 28 receives the second optical signal from the second transmitter 21 via the tenth terminal 10 and transmits the received second optical signal to the central office via the ninth terminal 9. The third optical filter 28 receives the second optical signal from each of the ONUs via the ninth terminal 9 and transmits the received second optical signal to the second receiver 22 via an eleventh terminal 11. In addition, the third optical filter 28 receives the first optical signal from the first transmitter 23 via the eleventh terminal 11 and transmits the received first optical signal to the ONUs via the ninth terminal 9. The first optical circulation unit 26, the second optical filter 27, and the third optical filter 28 reduce the number of optical fibers, which provide input signals, from four in the embodiments described with respect to FIGS. 1 and 3 to one in the current embodiment.

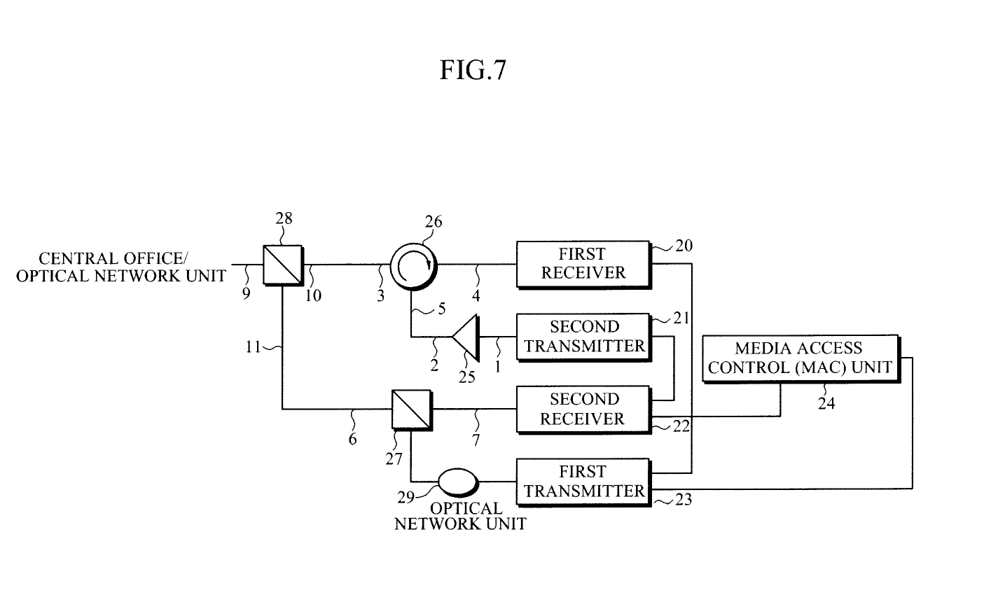

FIG. 7 is a block diagram of an optical transceiver suitable for use in a hybrid, passive optical network according to another exemplary embodiment.

Referring to FIG. 7, the optical transceiver of the hybrid, passive optical network includes a first signal processing unit, a second signal processing unit, a MAC unit 24, an optical amplification unit 25, a first optical circulation unit 26, a second optical filter 27, a third optical filter 28, and a first optical coupler 29. The first signal processing unit includes a first receiver 20 and a first transmitter 23, and the second signal processing unit includes a second transmitter 21 and a second receiver 22. The optical transceiver of the hybrid, passive optical network is located on the subscriber side.

The first optical coupler 29 transmits at least one of optical signals received from the first transmitter 23 to the ONUs and another plurality of ONUs. In addition, the first optical coupler 29 receives the second optical signal from each of the other ONUs and transmits the second optical signal to the second optical filter 27.

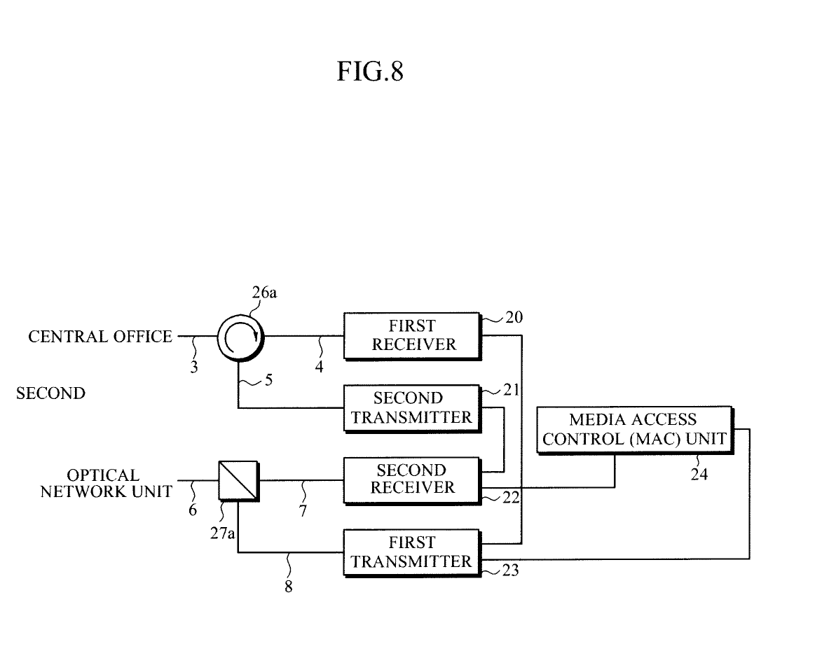

FIG. 8 is a block diagram of an optical transceiver suitable for use in a hybrid, passive optical network according to another exemplary embodiment.

Referring to FIG. 8, the optical transceiver of the hybrid, passive optical network includes a first signal processing unit, a second signal processing unit, a MAC unit 24, a second optical circulation unit 26a, and a fourth optical filter 27a. The first signal processing unit includes a first receiver 20 and a first transmitter 23, and the second signal processing unit includes a second transmitter 21 and a second receiver 22. The optical transceiver of the hybrid, passive optical network is located on the subscriber side.

The description of the optical transceiver of the hybrid, passive optical network is the same as that with respect to FIGS. 1, 3, 4, and 5 except for the following. The above-described elements will not be reiterated.

The second optical circulation unit 26a receives the first optical signal from the central office via the third terminal 3 and transmitting the received first optical signal to the first receiver 20 via the fourth terminal 4, and receiving the second optical signal via the fifth terminal 5 and transmitting the received second optical signal to the central office via the third terminal 3. The fourth optical filter 27a receives the second optical signal from each of the ONUs via the sixth terminal 6 and transmits the received second optical signal to the second receiver 22 via the seventh terminal 7, and receives the first optical signal from the first transmitter 23 via the eighth terminal 8 and transmits the received first optical signal to the ONUs via the sixth terminal 6.

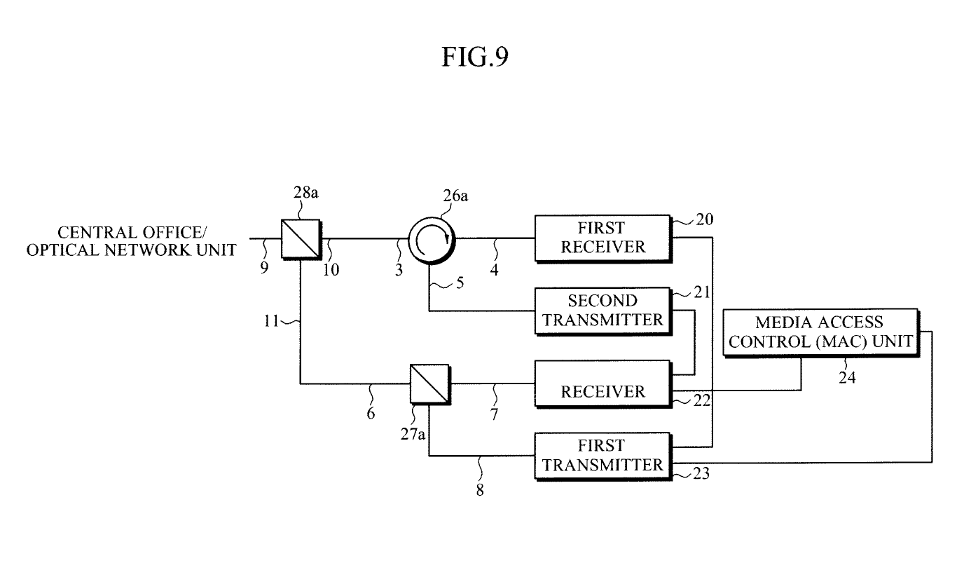

FIG. 9 is a block diagram of an optical transceiver suitable for use in a hybrid, passive optical network according to another exemplary embodiment.

Referring to FIG. 9, the optical transceiver of the hybrid, passive optical network includes a first signal processing unit, a second signal processing unit, a MAC unit 24, a second optical circulation unit 26a, a fourth optical filter 27a, and a fifth optical filter 28a. The first signal processing unit includes a first receiver 20 and a first transmitter 23, and the second signal processing unit includes a second transmitter 21 and a second receiver 22. The optical transceiver of the hybrid, passive optical network is located on the subscriber side.

The fifth optical filter 28a receives the first optical signal from the central office via a ninth terminal 9 and transmits the received first optical signal to the first receiver 20 via a tenth terminal 10, receives the second optical signal from the second transmitter 21 via the tenth terminal 10 and transmits the received second optical signal to the central office via the ninth terminal 9, receives the second optical signal from each of the ONUs via the ninth terminal 9 and transmits the received second optical signal to the second receiver 22 via an eleventh terminal 11, and receives the first optical signal from the first transmitter 23 via the eleventh terminal 11 and transmits the received first optical signal to the ONUs via the ninth terminal 9.

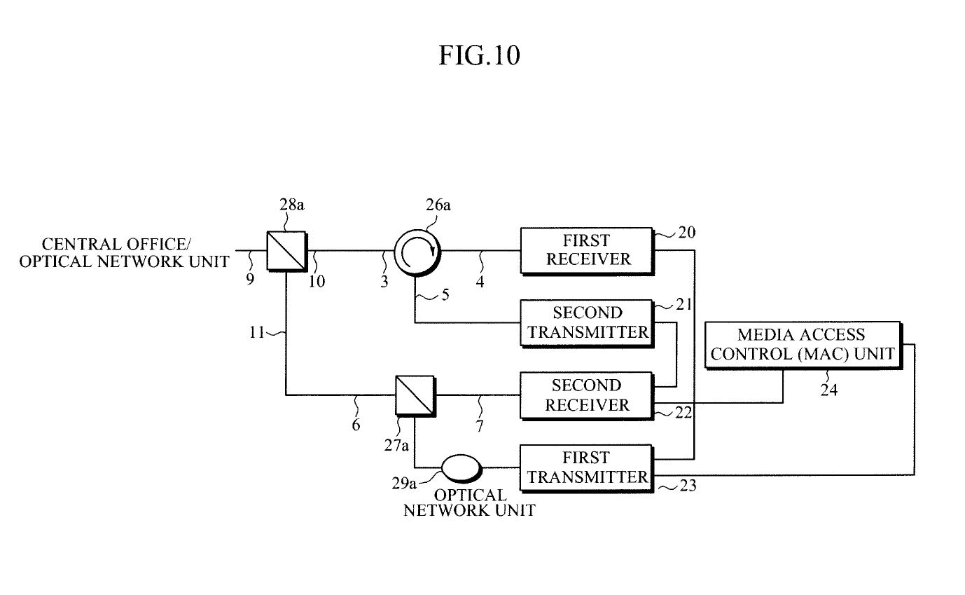

FIG. 10 is a block diagram of an optical transceiver suitable for use in a hybrid, passive optical network according to another exemplary embodiment.

Referring to FIG. 10, the optical transceiver of the hybrid, passive optical network includes a first signal processing unit, a second signal processing unit, a MAC unit 24, a second optical circulation unit 26a, a fourth optical filter 27a, a fifth optical filter 28a, and a second optical coupler 29a. The first signal processing unit includes a first receiver 20 and a first transmitter 23, and the second signal processing unit includes a second transmitter 21 and a second receiver 22. The optical transceiver of the hybrid, passive optical network is located on the subscriber side.

The second optical coupler 29a transmits at least one of optical signals received from the first transmitter 23 to the ONUs and another plurality of ONUs and transmits the second optical signal received from each of the other ONUs to the fourth optical filter 27a.

As described above, according to exemplary embodiments of the present invention, an active optical device for optical amplification and wavelength conversion and a MAC unit, are installed, at the subscriber side of a remote node, as a passive remote node. Therefore, the entire optical network can be efficiently operated.

According to exemplary embodiments of the present invention, a wavelength of an optical signal, which is transmitted or received, is tuned using a wavelength-tunable light source. Thus, a WDM-PON can be connected to a TDM-PON, without regard to wavelength compatibility.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. An optical transceiver suitable for use in a hybrid, passive optical network, comprising:
a first signal processing unit converting a wavelength of a first optical signal received from a central office and transmitting the first optical signal with the converted wavelength to one or more optical network units (ONUs);
a second signal processing unit converting a wavelength of a second optical signal received from each of the ONUs and transmitting the second optical signal with the converted wavelength to the central office; and
a media access control (MAC) unit setting a time frame in which each of the ONUs can transmit the second optical signal,
wherein the optical transceiver is installed at a subscriber side.

2. The optical transceiver of claim 1, wherein the first signal processing unit comprises:
a first receiver receiving the first optical signal from the central office; and
a first transmitter converting the wavelength of the first optical signal received by the first receiver and transmitting the first optical signal with the converted wavelength to the ONUs,
wherein the first receiver is connected to the central office by a wavelength division multiplexing passive optical network (WDM-PON), and the first transmitter is connected to the ONUs by a time division multiplexing passive optical network (TDM-PON).

3. The optical transceiver of claim 2, wherein the second signal processing unit comprises:
a second receiver receiving the second optical signal from each of the ONUs; and
a second transmitter converting the wavelength of the second optical signal received by the second receiver and transmitting the second optical signal with the converted wavelength to the central office,
wherein the second receiver is connected to the ONUs by the TDM-PON, and the second transmitter is connected to the central office by the WDM-PON.

4. The optical transceiver of claim 2, wherein the first receiver is configured using a P-I-N photodiode or an avalanched photodiode.

5. The optical transceiver of claim 2, wherein the first transmitter is configured using a directly modulated, wavelength-fixed light source.

6. The optical transceiver of claim 3, wherein the second receiver is configured using a P-I-N photodiode or an avalanched photodiode.

7. The optical transceiver of claim 3, wherein the second transmitter is configured using a continuous output wavelength-tunable light source and an external modulator which modulates an optical signal output from the wavelength-tunable light source or configured using a directly modulated, wavelength-tunable light source.

8. The optical transceiver of claim 3, wherein the second transmitter is configured using a directly modulated reflective semiconductor optical amplifier or a Febry-Perot laser diode (FP-LD).

9. The optical transceiver of claim 3, further comprising:
an optical amplification unit at a front end of the second transmitter,
wherein the optical amplification unit is either a doped fiber amplifier or a semiconductor optical amplifier.

10. The optical transceiver of claim 9, wherein the first receiver and the second transmitter are connected to either an optical circulator or an optical power splitter.

11. The optical transceiver of claim 9, wherein the second receiver and the first to transmitter are connected to either an optical circulator or an optical wavelength division multiplexing (WDM) filter.

12. The optical transceiver of claim 3, further comprising:
an optical WDM filter multiplexing wavelengths of a WDM signal and a time division multiplexing (TDM) signal.

13. The optical transceiver of claim 3, further comprising:
an optical power splitter at a front end of the first transmitter,
wherein the optical power splitter can communicate with the ONUs.
